(19) United States
(12) Patent Application Publication
(10) Pub. No.: US 2006/0180570 A1
(43) Pub. Date: Aug. 17, 2006

(54) Application of in-situ plasma measurements to performance and control of a plasma processing system

(76) Inventor: Leonard J. Mahoney, Fort Collins, CO (US)

Correspondence Address: COOLEY GODWARD LLP;ATTN: PATENT GROUP, THE BOWEN BUILDING, 875 15TH STREET, N.W. SUITE 800, WASHINGTON, DC, 20005-2221, US

(21) Appl. No.: 11/352,012

(22) Filed: Feb. 10, 2006

Related U.S. Application Data
(60) Provisional application No. 60/653,070, filed on Feb. 14, 2005.

(51) Int. Cl. G01L 21/30; C23F 1/00

(52) U.S. Cl. 216/59; 216/67; 156/345.28

(57) ABSTRACT

A system and method for managing a plasma system is described. In one embodiment the method includes measuring at least one aspect of a state of plasma in the plasma system so as to obtain plasma state data, receiving subsystem data, which is indicative of at least one subsystem of the plasma system and utilizing both the plasma state data and the subsystem data to manage the plasma system.

### PRIORITY

The present application claims priority from application No. 60/653,070 Attorney Docket No. ADPL-007/00, entitled APPLICATION OF IN-SITU PLASMA MEASUREMENTS TO PERFORMANCE AND CONTROL OF A PLASMA PROCESSING SYSTEM, which is incorporated herein by reference.

### FIELD OF THE INVENTION

This invention relates generally to methods of collecting and analyzing measurements of in-situ plasma properties in a plasma processing system, and more particularly to methods of characterizing the spatial and temporal state of the system for purposes of improving system performance, decreasing process variability, and increasing process yield and throughput.

### BACKGROUND OF THE INVENTION

Industrial plasma processing systems are typically complex assemblies of components and subsystems that may comprise one or more vacuum chambers; pumps and valves; power supplies (both DC and AC); electrodes and/or induction elements; substrate holders or chucks; gas flow manifolds and controls; cooling apparatus or chillers; and measurement and sensing equipment such as voltage, current, power and impedance sensors, vacuum gauges, and optical sensors. Variations in the operation or performance of any of these system elements can actively affect the physical properties of the processing plasma, which in turn generally affects the outcome of the process. In the case of a plasma etching system, for example, fluctuations in power delivery, gas flow rates, and workpiece temperatures are known to affect critical process metrics such as etch rates, depths and profiles.

Particularly in the fabrication of semiconductor devices, uniformity of process conditions at each step of the fabrication process is vital to ensure product quality and throughput. Because of the susceptibility of plasma systems to uncontrolled variations, transients, and drifts, however, maintaining adequate process yield is a constant challenge. In an effort to improve process control, one approach has been to compile apparent correlations between process tool parameters (for example, power and gas flow settings) and product metrics (for example, etch dimensions and characteristics), with these correlations in turn being used to effect adjustments to tool settings for process improvement. Because of the need for post-process inspection, however, the utility of this approach is generally limited to informing run-to-run process recipe adjustments. Moreover, due to the multivariant and nonlinear dependencies of product metrics upon process input variables, bulk correlations between these states are of little use in identifying the probable cause of a process drift or fault, let alone in enabling any meaningful real-time monitoring or control of the process.

In another approach, in-situ or ex-situ process data have been employed for optimization and control of process sub-systems, as for example the use of power, flow or pressure measurements to regulate the operation of power supplies or flow control devices. While providing a degree of localized optimization of process operations at the component level, this approach does not purport to monitor or control process metrics of the integrated system as a whole. With too few state signals in relation to the number of significant inputs into the process, and in particular without sensory data representative of the condition of the processing plasma itself, the plasma state can still vary or drift even with fixed and well regulated subsystem inputs.

With the emergence of non-invasive, in-situ plasma sensor technologies, it has become possible to obtain measurements of actual physical and electrical properties of a plasma within an operational plasma processing environment. For example, sensor devices may be disposed upon a wireless wafer-based probe device that may be cycled like any other workpiece into the process environment, or alternatively may be disposed in fixed arrays within the processing equipment itself. Data related to plasma boundary or bulk properties collected by in-situ measurement devices may be used for characterization of both temporal and spatial dynamics of plasma processing systems as used in various semiconductor electronics fabrication steps, for example, or in various optical and industrial material coating or surface treatment applications. Descriptions of exemplary apparatus and methods for in-situ, noninvasive plasma metrology may be found in U.S. Pat. Nos. 6,830,650 and 6,902,646.

In-situ plasma measurement devices, however, may suffer wear with exposure to the plasma environment being monitored and, when not being re-charged within the plasma environment, may have limited energy reserves for wireless operation. This is particularly true for wafer-based in-situ devices that are comprised of thin-film layers and exposed to harsh physical, thermal and chemical conditions when disposed in a plasma processing system. As a result, it would be desirable to obtain substantive in-situ measurement information with minimal exposure time, limited wear of protective thin films, sensor and mechanical structures, and reduced peak amplitude of thermal excursions in the plasma.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

This invention provides methods for obtaining substrate surface and plasma measurements from an in-situ measurement device in a plasma processing system and for characterizing the temporal and spatial state of the plasma properties as needed for determining the plasma system response and variability. Subsequent analysis is used to improve overall process control and enable plasma process system matching between similar or even dissimilar plasma system platforms. The method includes dynamically changing process system variables at or about an operating point in order to deduce response levels and transient characteristics of the plasma boundary incident to the sensing device. These dynamic spatial and temporal responses are then compared to trend lines or process “fingerprints” and associated control limits so as to identify out-of-tolerance levels or variation in the system's operation. The method provides for subsequent analysis of the measurements to help identify faulty operation of the plasma processing system or identify potential causes for such faults.

In one embodiment of the invention, a wireless plasma measurement device comprises a wafer substrate, associated electronics and microcontroller and one or more patterned sensors for obtaining plasma boundary or bulk properties. The device is disposed into a plasma processing chamber used for semiconductor electronics manufacture to record temporal and/or spatial measurements. The method also includes prescribing one or more process steps that are at or about a reference manufacturing process condition of interest. Recording of the plasma properties is triggered by sensing the presence of the plasma in the system or other dynamic changes in sensor readings when the plasma is ignited. Measurements are recorded and stored throughout the process recipe steps or process sequence. The device is removed from the processing system and the recorded data is uploaded after the termination of the process from the device through a wireless link into an external computer for analysis. The method further includes an analytical comparison of the measurements to reference trend-lines with associated control limits. Decisions as to the viable operation of the plasma processing system are then enabled by the operator depending upon how closely the measured levels, variation or transients are within tolerance of the pre-described control settings.

In another embodiment of the invention, a version of wireless measurement device fabricated onto a wafer substrate is disposed in the processing system and exposed to a single process condition that is periodically cycled on and off. The cycled process system condition time period is substantially shorter than a normal manufacturing process allowing for limited exposure of the device to chemical, physical or thermal induced wear of the device's surfaces. After the termination of the cycled process, the device is removed from the system and the recorded data are uploaded from the device through a wireless link into an external computer for analysis. By statistically evaluating the replicated temporal signature response of the plasma system, or fingerprint, a higher resolution of the system's measured response and variance is obtained without running the plasma system for long time periods as would normally be encountered in standard manufacturing practice. With the increase in resolution obtained through multiple sampling events of the cycled process condition, the method provides a high degree of confidence in accessing the variability of the plasma processing system and its viable operation in manufacturing, particularly with regard to variations and yield issues that are associated within transient behavior of the processing system.

In another embodiment of the invention, a version of wireless measurement device fabricated onto a wafer substrate is disposed in a plasma processing system and is exposed to a sequence of process steps wherein the system inputs are adjusted varied about a center-point process condition of interest. The domain of the system settings and the measured response define a DOE (Design of Experiment) structure or other type of empirical response surface. In the preferred embodiment, the period of the sequence is made short, on the order of about 5-15 seconds, and may include replications of the center point or other reference settings. This is done to obtain the maximum response surface information in the shortest time-period possible and thus optimize the available working lifetime of the measurement device. The results of the analyzed DOE or other response surface enables evaluation of viable system operation for manufacture and provides a measure of the robustness of process settings of interest. Also, the response model from the DOE or response surface can be used to advise an operator as to what input system variables could be in error or could be adjusted so as to correct the system response back to or towards improved manufacturing performance. Moreover, such a method can be utilized to aid in fault detection and classification methodologies and feed-forward and feed-back correction of process input settings.

In another aspect of the invention, the plasma measurements collected by the measurement device may be combined with historical chamber used data and other non-invasive ex-situ process system measurements such as optical emission spectra; RF power, substrate bias voltage, current and phase information; in-situ rate and uniformity (etch or deposition) metrology data; or post-process evaluations of achieved etch rates, critical dimensions, film stresses, end points, and yields in order to expand the empirical scope of the response surface and related analysis of the process system. This method is particularly helpful in deterministically resolving and de-coupling the influence of input power conditions on the plasma boundary and bulk properties from the influence of input chemistry (i.e. flow balances and residence time). Identifying deterministic relationships between the plasma system inputs and measured plasma properties, as well as other responses, is highly advantageous when applying advanced process control methods where one desires to reduce overall variance and enhance repeatability within manufacturing.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates temporal measurement plasma ion saturation current, surface temperature, and surface charge voltage induced by the plasma as obtained from a wafer diagnostic device when exposed to a typical process recipe.

FIGS. 2a and 2b illustrate the transient responses of temporal plasma measurements obtained from a diagnostic device at the advent of the process recipe or when the plasma is first ignited to start the process.

FIG. 3 illustrates temporal plasma and surface measurements obtained from a diagnostic device when exposed to cycled step-inputs of a single process condition.

FIG. 4 illustrates temporal plasma and surface measurements obtained from a diagnostic device when exposed to cycled high- and low-power process conditions.

FIG. 5 illustrates temporal plasma and surface measurements obtained from a diagnostic device when exposed to cycled process sequence wherein the process system settings are varied about a repeated center point condition to perform a DOE or other parametric or surface response evaluation of the process system's performance.

FIG. 6 illustrates a flow diagram that outlines an exemplary method for monitoring and resolving a plasma process system state.

### DETAILED DESCRIPTION

In-situ plasma diagnostic devices incorporate sensors and associated electronics for the purpose of obtaining and recording plamsa and substrate surface measurements when disposed into a plasma processing system. The in-situ devices may incorporate several sensors including a dual floating Langmuir probe (DFP) for measuring ion currents, surface charging or electrostatic charge sensors, surface temperature sensors, optical sensors to observe radiated plasma emissions, ion angle sensors and topographically dependent charging sensors to name but a few examples. For purposes of illustrating the method of this invention, a wireless-based wafer apparatus is described having a single DFP sensor, surface temperature sensor and surface charging sensor that can be disposed into a plasma processing system to take spatial and temporal measurements. However, the method also applies to any other in-situ plasma diagnostic device or sensor apparatus. The plasma system used in the illustration is similar to that used in normal wafer manufacture and has a vacuum chamber and pressure control means, a work-piece chuck, and input variables that include RF (or DC) power, various gas flows temperature controls, magnetic fields settings, and historical chamber data. There may also be included additional ex-situ diagnostic capabilities such as optical emission sensors, RF power current, voltage and phase sensors or mass spectrometer, to name only a few examples, whose data can be used in conjunction with the wafer device for diagnosing or characterizing the state of the processing system. Also included is a transceiver that communicates between the diagnostic device and an external computer for the purpose of uploading data from the device and performing subsequent graphical presentation and analysis of the data. This will hereafter be referred to as the device “basestation.”

The in-situ measurement device is placed into the process chamber, preferably through the conventional vacuum load-lock and mechanical wafer handling mechanisms associated with the process system. The device is then exposed to alignment, fixturing or electrostatic chucking as a normal part of the plasma systems operation. The device is then exposed to plasma process recipe or sequence which activates the device sensors to measure the response temporal and spatial response in the presence of the plasma. Once the sequence has been completed and the device is within adequate proximity to its associated basestation, the device uploads the recorded measurements for subsequent graphical display and analysis.

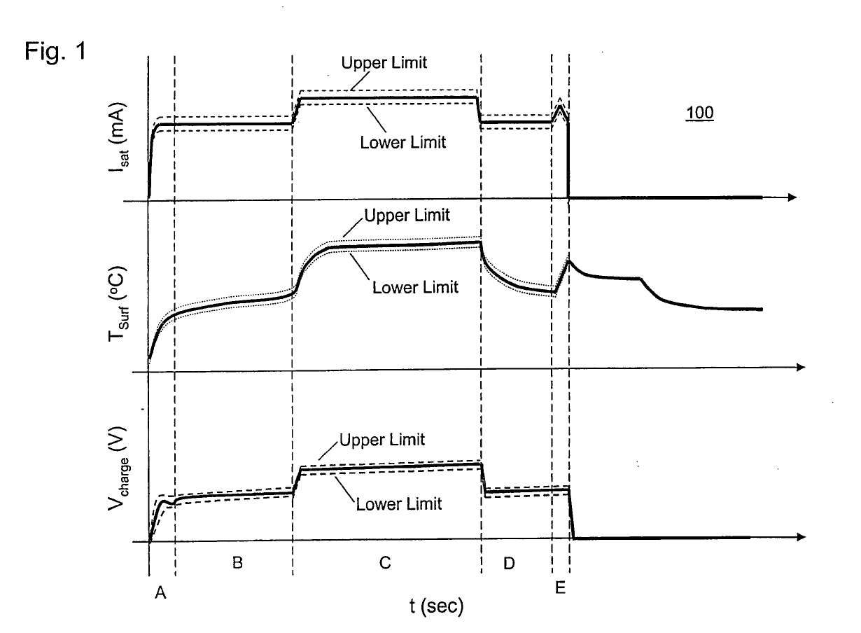

FIG. 1 illustrates the typical response of the in-situ measurement device when exposed to a process sequence or recipe that may be used for either etching or deposition operations on a wafer work-piece in manufacture. The recorded response includes trend lines for ion saturation current as measured by the DFP sensor, surface temperature as measured by a temperature sensor disposed on the wafer surface, and a surface charge as induced by the incident electrostatic plasma conditions on a voltage sensor or topographical charge device (TDC) sensor. It is understood that the trend lines shown in FIG. 1 are for illustration purposes and could alternatively be a series of trend lines or fitted multi-dimensional surfaces corresponding to spatial measurements from multiple sensors distributed over the wafer. In this example the illustrated trend lines show response to a multiple step process sequence that includes the following:

(A) a turn-on or plasma ignition transient or ramp,

(B) a main process step less the initial transient,

(C) a secondary process step,

(D) a third process step, and

(E) a de-chucking and plasma-off or ramp-down step.

Associated with the signals are upper and lower control limits that may extend over the entire temporal signature of the measurements and may include high and low control limits that envelop the temporal signatures.

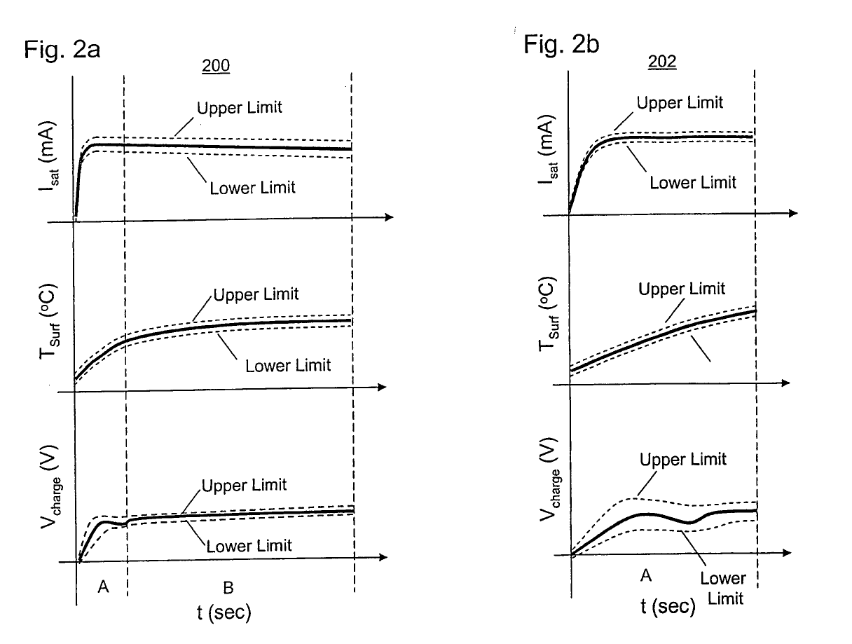

In practice, trend lines associated with plasma boundary and bulk properties, such as ion saturation current and plasma induced charging, have fairly fast step-wise responses to plasma ignition and thus can track transients that may be the result of RF power train and impedance matching tuner dynamics, input gas flow controllers undershoot and overshoot, or pressure control dynamics. By contrast, the thermal sensor which depends upon thermal mass and heat transfer through the wafer substrate is not nearly as sensitive and therefore shows a smoothed, asymptotic response to the plasma sequences. This is illustrated in FIG. 2a where sensor responses are shown for ignition step (A) and process step (B). FIG. 2b illustrates shows the transient responses of all sensors within the ignition step (A). Within the ignition step, the transients oscillations, overshoots, and undershoots of the plasma state are easily observed with plasma-based sensors. By this means, transient behavior associated with ignition of the plasma or at step-wise excursions between process steps is characterized. Moreover, is possible to identify anomalous transient behavior of the plasma processing system that indicate out-of-control or non-optimal performance of sub-system components.

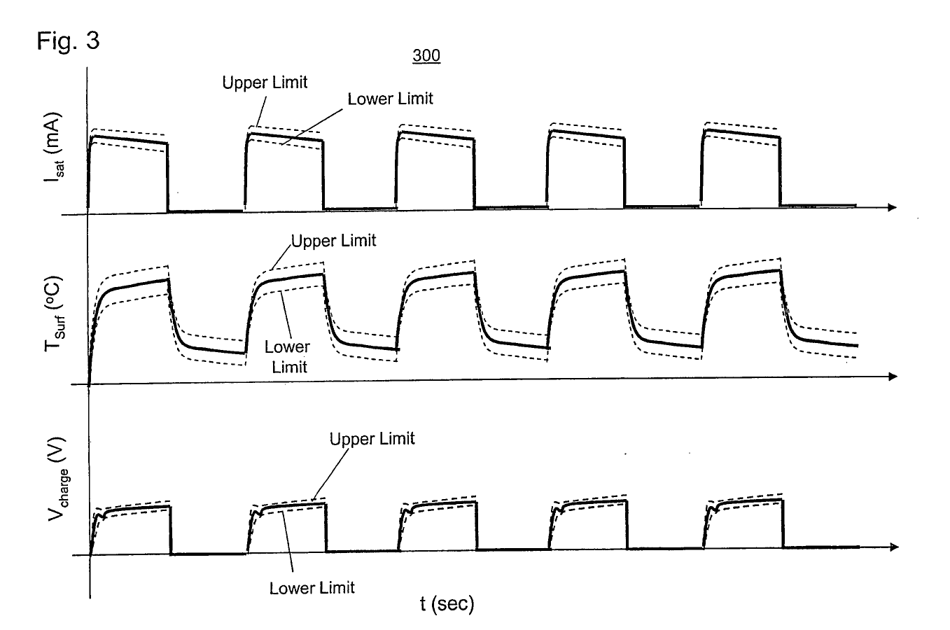

FIG. 3 illustrates another manner of obtaining a process system's characteristic when cycling the plasma process power. The cycled settings generate replicated measurement signatures. Using this sampling approach, the variance associated with either transients or steady-state properties is estimated. Moreover, by cycling the power on and off with a moderate duty cycle, replicated measurements are collected while substantially limiting the device's integrated exposure to wear and high temperatures when characterizing high power density and chemically corrosive plasma conditions. Alternatively, the data sequence itself is used as a test profile about which upper and lower control limits are be applied.

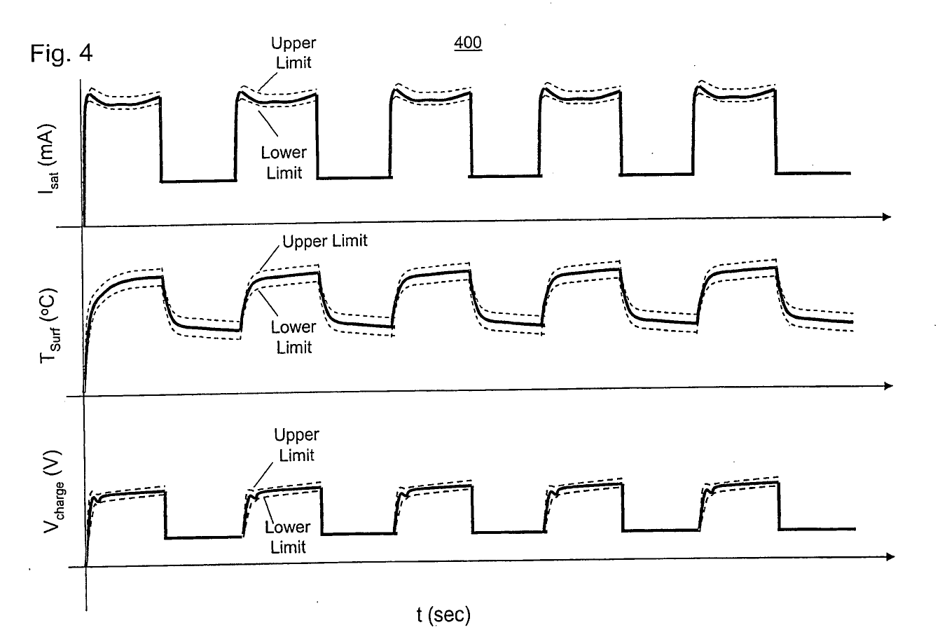

FIG. 4 illustrates a sampling approach similar to the on-off cycled method of FIG. 3, but in this instance the cycled power settings are reduced from the peak power settings of interest. This means of collecting measurements would be preferred if it is desirable to avoid plasma re-ignition transients or if it is merely desirable to reduce the power flux and peak operating temperatures, particularly on a wireless-based wafer device, that lead to wear and stress of the measurement device. As with the prior case, the data sequence may be itself used as a test profile about which upper and lower control limits can be applied.

In both preceding cases, the cycled plasma processing condition (as may be achieved with cycling the power into the plasma) results in fiducial features within the temporal measurements. Such features are highly advantageous when aligning the device measurements with recorded process system variable data or other temporal measurements made on the plasma processing system.

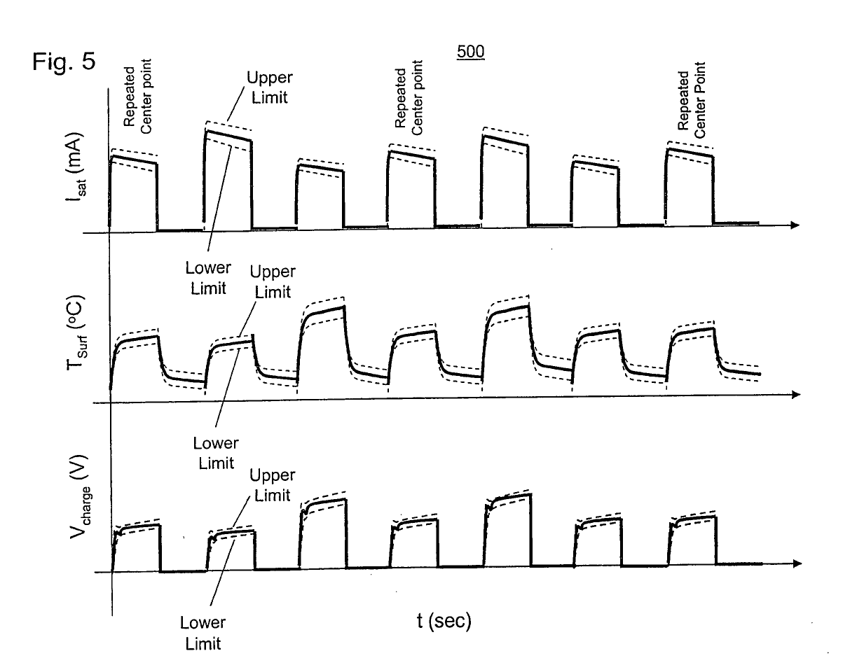

The foregoing discussion describes methods for obtaining in-situ plasma measurements at a single process setting or sequence. FIG. 5 illustrates how similar measurements can be obtained by adjusting process system input variables in a step-wise manner to facilitate parametric testing, design of experiments or empirical surface response positioned about a center point operating condition of interest. The device response is made by step-wise, multivariate adjustments of system input factors such as powers, flows, chemistry balance, or pressure. As discussed earlier, it is sometimes desirable to also include cycled on-off steps between the multivariate settings to produce fiducial features in the temporal data for alignment to other process system temporal measurements or to mitigate thermal stress of the in situ measurement device and other wear factors when directly exposed to the plasma processing environment. As with all other cases, the measured experimental response can be employed as a test profile to which upper and lower control limits can be applied.

One example of incorporating in-situ and ex-situ measurements is the use of the measurements from the instrumented wafer device along with optical emission spectra data and RF power current, voltage, phase and frequency data related to powering the plasma or providing a bias voltage to the wafer chuck or substrate holder within the plasma processing system. By incorporating these additional ex-situ measurements, whose temporal responses are often similar in feature to the in-situ measurements, a multivariable response is obtained that better characterizes and quantifies the influence of all significant input factors (power, pressure, flows, wall temperature and chemistry balance) upon the spatial and temporal state of the plasma processing system.

The in-situ data are used to achieve several specific objectives for process monitoring and control. These objectives include the following: 1) “fingerprinting” of normal chamber conditions for statistical process control Go/No-Go decisions, 2) fault detection and classification (FDC), 3) so-called “smart” FDC which include features for determining root causes for faults and/or decision trees for returning the chamber back to nominally acceptable conditions, and 4) advanced process control methods for feed-forward or real-time process control targeted around a specific process operating recipe or center point or set of process steps. The in-situ data may be used alone or in conjunction with other plasma processing system data such as input variable data; sub-system response data (e.g. read backs on power, flows and pressure instrumentation); other diagnostic data such as optical emission spectra or power readings including current, voltage and phase measurements made at the electrical connection to the plasma source and/or the biased workpiece; and process metrics such as achieved etch rates, critical dimensions, film stresses, end points, and yields.

In many instances, single-variable time-series analysis can be performed to develop fingerprint characteristics from measurements acquired by one or more sensors on the device. This approach involves characterizing the temporal response of a time-series set of data against plasma ignition, steady state settling times and related transients. Common statistical methods are used to reduce the temporal response to values such as range, average, standard deviation, and partial modeling of waveform signatures for comparison to historically established waveform trends and known variances. Other forms of single-variable analysis can be applied to characterizing to transients behavior such as slope, overshoot, stabilization time, and ringing coefficients.

In other instances, the multidimensional nature of the data is considered in order to achieve the monitoring and control objectives. Many of the primary techniques for operating on multidimensional data (in-situ measurements with or without ex-situ measurements) are based on tessellation or clustering of historically reliable data (sometimes referred to as “golden runs”) in order to form bounded regions of viable operation within the multidimensional data space. Examples of conventional methods used for developing these cluster and bounded regions include familiar mathematical techniques such as least squares, partial least squares, and principle component analysis.

Alternatively, other known numerical or statistical analysis techniques are used for achieving monitoring and control objectives including, but not limited to, neural network methods, fuzzy logic, self organizing maps and networks, K-NN means clustering, hierarchical clustering, decision trees, hidden Markov models, radial bias functions, support vector machines and various deterministic systems state machines for control on historical and new input data.

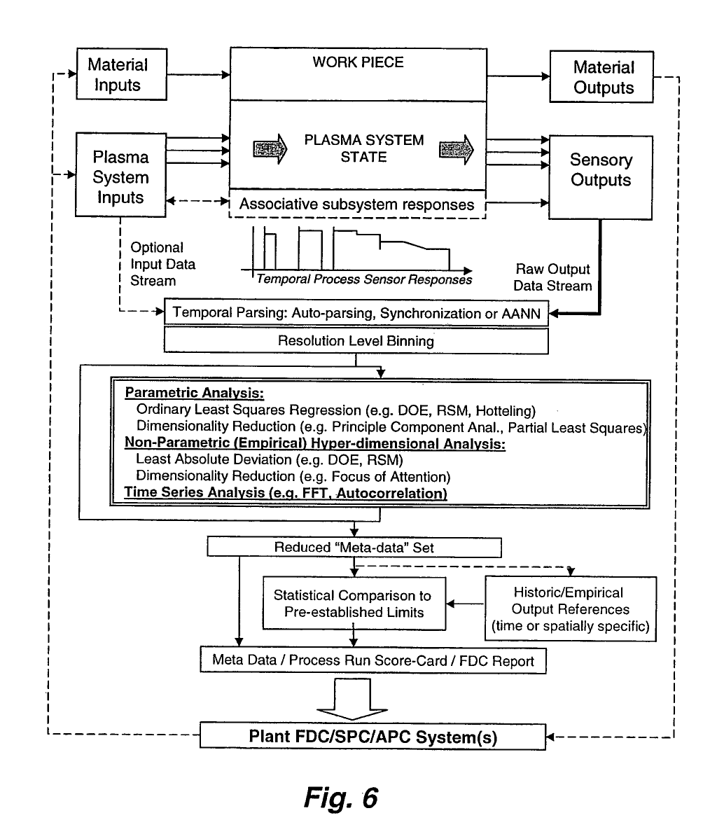

Referring next to FIG. 6, shown is a flow diagram that outlines one method for monitoring and resolving a plasma process system state. As depicted, the process system has material workpiece inputs and outputs such as input lithography pattern and the resulting critical dimensions of the etched features.

In addition, the process system in this embodiment includes plasma system inputs and outputs. In some embodiments, for example, plasma system inputs include power (single or multiple frequencies), pressure, flow, temperature, switched electrodes and/or magnetic field settings. In the context of DC and pulsed-DC systems, system inputs may include current, voltage, pulse width, frequency, reverse time settings and/or duty cycle inputs.

Some examples of plasma state sensory output responses include optical emission spectroscopy line intensities, non-intrusive plasma property signals such as multiple ion saturation current and differential charging potentials detected by an instrumented wafer as discussed in U.S. Pat. No. 6,830,650 or a focus ring as disclosed in U.S. Pat. No. 6,902,646. In addition, in some variations outputs are received relative to ion velocity, energy sensors, mass spectrometer (for partial pressure readings), in situ deposition rate monitors, SEERs diagnostic sensors, acoustic sensors and particle detection sensors.

Also depicted in FIG. 6 are associative plasma sub-system output responses, which in several embodiments includes RF Power Systems outputs, DC Power System outputs and/or vacuum and flow system outputs.

As depicted, multivariate time-series data is collected (real-time or logged) and parsed. In many embodiments, the data is auto-parsed with numerical or time-series analysis and synchronized to an input data stream (if available). In variations, the data is also analyzed by an attribute selective or pattern recognition algorithm such a hierarchy of tree-connected, auto-associative, neural network nodes which can detect and categorize features in the time-series data stream.

As depicted in the exemplary embodiment, the parsed multivariate data is then categorized through resolution level binning, which provides a first level of reduced “meta data,” which characterizes, at least in part, the temporal and/or spatial state of the plasma system.

As shown in FIG. 6, the parsed and bin resolved data in many variations is then further analyzed through parametric analysis (e.g., ordinary least squares regression), non-parametric analysis (e.g., least absolute deviation analysis) and/or time series analysis (e.g., fast fourier transform analysis to isolate spectral content of data).

In accordance with several embodiments, the data is further reduced to form “meta data.” As used herein, meta data refers to any aspect of the raw time-series multivariate data (inputs or outputs) that is reduced to averages, measures of variability, and/or differences or modeled parameters that are intended to define attributes of the plasma processing system state.

Advantageously, the meta data provides a much more concise view of the plasma system state relative to the raw data from the sensory outputs. As a consequence, the meta data is often times much more manageable and more amenable to meaningful analysis relative to the raw, unreduced data. As depicted, in many embodiments, the meta data may be statistically compared to pre-established upper and lower limits or to historical/empirical reference data (e.g., temporal specific, spatial specific and/or spectral specific data).

As depicted in the exemplary embodiment, the meta data or results of statistical comparison may then be reported directly to the user host system for FDC/SPC or APC application, used to form a process score-card or assessment to report goodness of process state or identify instances of faults, excursions or unexpected variances. In addition, the meta data may be utilized to provide an alarm on faults and provide any classification report relative to out of tolerance faults.

In accordance with some aspects of the present invention, aspects of the reduced data and subsequent analysis is reported to the manufacturing plant host system to help facilitate plant level FDC, SPC or APC operations.

In many variations, for example, the raw data stream that is subsequently processed, in accordance with the process described with reference to FIG. 6, is utilized not only to monitor the plasma system, but also to control the plasma system.

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing a plasma system comprising:
measuring at least one aspect of a state of plasma in the plasma system so as to obtain plasma state data;
receiving subsystem data, the subsystem data being indicative of at least one subsystem of the plasma system; and
utilizing both the plasma state data and the subsystem data to manage the plasma system.

2. The method of claim 1, wherein the managing includes controlling plasma system inputs utilizing the plasma state data and the subsystem data.

3. The method of claim 3, wherein the plasma state data and the subsystem data provide a determinative amount of system data.

4. The method of claim 1, wherein the managing includes a management action selected from the group consisting of enhancing performance of the plasma system, decreasing process variability, increasing product yield and increasing product throughput.

4. The method of claim 1 including:
reducing the plasma state data and the subsystem data to a reduced level of data; and
utilizing the reduced level of data to manage the plasma system.
